(19) United States
(12) Patent Application Publication
(10) Pub. No.: US 2026/0131815 A1
(43) Pub. Date: May 14, 2026

(54) RECREATIONAL VEHICLE VISION SYSTEM

(71) Applicant: Polaris Industries Inc., Medina, MN (US)

(72) Inventor: Soumya Dash, Bangalore (IN)

(21) Appl. No.: 19/375,769

(22) Filed: Oct. 31, 2025

Related U.S. Application Data
(60) Provisional application No. 63/719,887, filed on Nov. 13, 2024.

(51) Int. Cl. B60W 50/14; B60K 35/28; G06T 7/70

(52) U.S. Cl. CPC B60W 50/14; B60K 35/28; G06T 7/70; B60K 2360/171; B60K 2360/176; B60K 2360/178; B60K 2360/589; B60W 2050/146; B60W 2300/362; B60W 2420/403; B60W 2540/18; B60W 2556/45; G06T 2207/30252

(57) ABSTRACT

Vision systems may be used to aid complex maneuvers of recreational vehicles, particularly when an operator's view of objects is obstructed by portions of the vehicle. A recreational vehicle vision system may include a camera, processing circuitry, and a display device. The camera may be mounted to any suitable portion of the recreational vehicle. The processing circuitry is configured to receive image data from the camera, detect an object in the image data that is obscured from direct view of an operator of the recreational vehicle, and generate a virtual projection of the detected object. The display device is configured to display at least a portion of the image data and at least a portion of the virtual projection.

### CROSS-REFERENCE TO RELATED APPLICATIONS

The present application claims priority from U.S. Provisional Patent Application No. 63/719,887, filed on Nov. 13, 2024, the disclosure of which is hereby incorporated by reference in its entirety.

### BACKGROUND

Owners and operators of recreational vehicles, including side-by-side vehicles, all-terrain vehicles, recreational utility vehicles, snowmobiles, and other such vehicles, primarily operate such vehicles in areas off of highways and roads. With the widespread growth in the large variety of types of vehicles and their utility, recreational vehicles may be operated for many different purposes, including recreation, utility, and even general transportation. As a result, operators of recreational vehicles may find themselves in a variety of situations where automated assistance from the recreational vehicle itself could be helpful and even safety enhancing.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In some examples, the disclosure describes recreational vehicle vision systems including a camera, a display, and processing circuitry. The camera is mountable to a portion of a recreational vehicle. The camera is configured to generate image data indicative of an environment around the recreational vehicle. The display device is configured to display information to a user. The processing circuitry is communicatively coupled to the camera and the display. The processing circuitry is configured to receive image data from the camera. The processing circuitry is further configured to determine, based on the image data, a position of an object that is obscured from direct view of at least one of the camera and an operator of the recreational vehicle. The processing circuitry also is configured to generate virtual projection data indicative of the object at the position. The processing circuitry also is configured to transmit display data including at least a portion of the image data and at least a portion of the virtual projection data to the display device.

In some examples, the disclosure describes a method of enhancing visibility for a recreational vehicle operator. The method includes receiving, by processing circuitry, image data from a camera mountable to a portion of a recreational vehicle. The image data is indicative of an environment around the recreational vehicle. The method also includes analyzing, by the processing circuitry, the image data to determine a position of an object obscured from direct view of at least one of the camera and an operator of the recreational vehicle. The method also includes generating, by the processing circuitry, virtual projection data indicative of the object at the position. The method also includes transmitting, by the processing circuitry to a display, display data including at least a portion of the image data and at least a portion of the virtual projection data.

In some examples, the disclosure describes a recreational vehicle having a vision system. The recreational vehicle includes a roll-over protection system (ROPS) and a camera mounted to the ROPS. The recreational vehicle also includes processing circuitry communicatively coupled to the camera and configured to receive image data therefrom. The recreational vehicle also includes a display device communicatively coupled to the processing circuitry. The processing circuitry is configured to analyze the image data to identify potential obstacles in a path of the recreational vehicle. The processing circuitry is configured to generate a graphical overlay indicating the identified potential obstacles. The processing circuitry is configured to cause the display device to present the graphical overlay superimposed on a portion of the image data.

The foregoing general description of the illustrative embodiments and the following detailed description thereof are merely examples of the teachings of this disclosure and are not restrictive.

### BRIEF DESCRIPTION OF THE DRAWINGS

The disclosure can be understood in consideration of the following detailed description of various embodiments in connection with the accompanying drawings.

FIGS. 1 through 6 are conceptual diagrams illustrating various views of an example recreational vehicle having a vision system.

FIG. 7 is a conceptual diagram illustrating an example camera of a recreational vehicle vision system that is mountable to a roll-over protection system of a recreational vehicle.

FIG. 8 is a conceptual diagram illustrating an example recreational vehicle vision system.

FIG. 9 is a conceptual diagram illustrating an example graphical user interface with a display generated by a recreational vehicle vision system.

FIGS. 10A through 10C are conceptual diagrams illustrating example graphical user interfaces with a display generated by a recreational vehicle vision system.

FIG. 11 is a flow diagram illustrating an example technique for generating a virtual projection of an object obscured from a direct line of sight of a camera of a recreational vehicle vision system.

### DETAILED DESCRIPTION

For purposes of promoting an understanding of the principles of the disclosure, reference will now be made to the embodiments illustrated in the drawings, and specific language will be used to describe the same. It will nonetheless be understood that no limitation of the scope of the disclosure is intended by the illustration and description of certain embodiments of the disclosure. In addition, any alterations and/or modifications of the illustrated and/or described embodiment(s) are contemplated as being within the scope of the present disclosure. Further, any other applications of the principles of the disclosure, as illustrated and/or described herein, as would normally occur to one skilled in the art to which the disclosure pertains, are contemplated as being within the scope of the present disclosure.

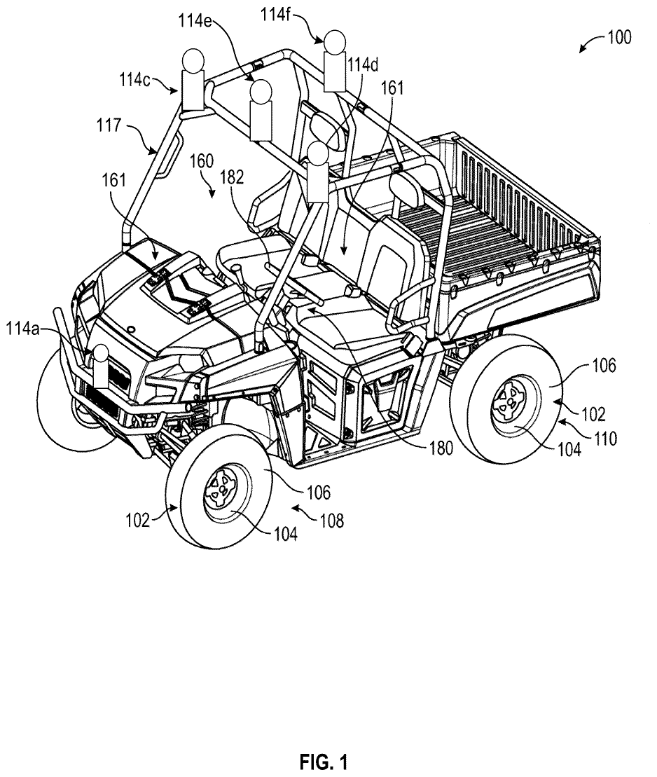

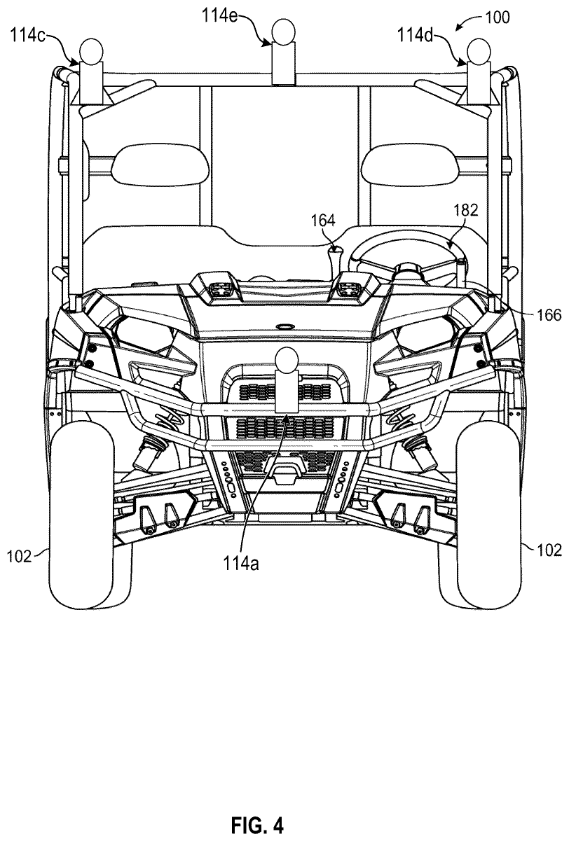

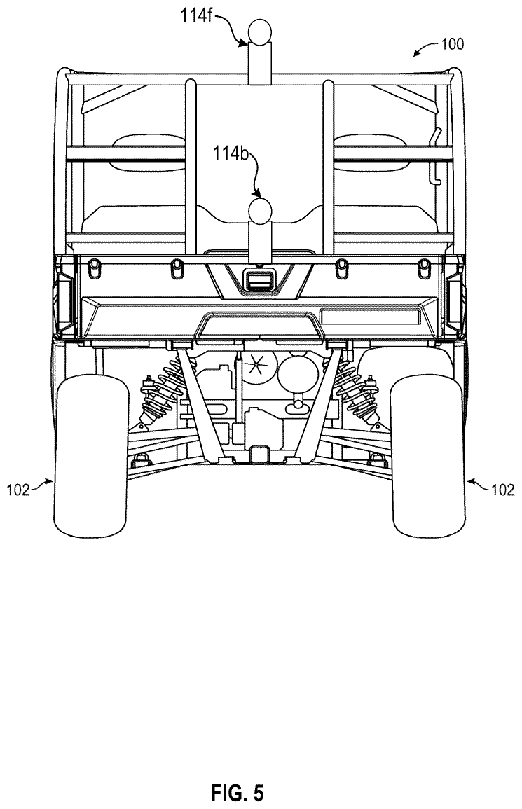

FIGS. 1 through 6 are conceptual diagrams illustrating various views of an example recreational vehicle 100 (hereinafter, vehicle 100) having a vision system. Vehicle 100 includes a side-by-side off-road vehicle (ORV). In other examples, vehicle 100 may include any of a variety of recreational vehicles whose primary purpose is to travel on terrain other than paved roadways, including, but not limited to, all-terrain vehicles (ATVs), utility terrain vehicles (UTVs), off-highway motorcycles (OHMs), snowmobiles, and other off-road vehicles.

Vehicle 100 includes a plurality of ground engaging members 102. Illustratively, ground engaging members 102 are wheels 104 having tires 106. Other examples of ground engaging members may include, but are not limited to, skis, tracks, or combinations thereof. In one embodiment, one or more of wheels 104 may be replaced with tracks.

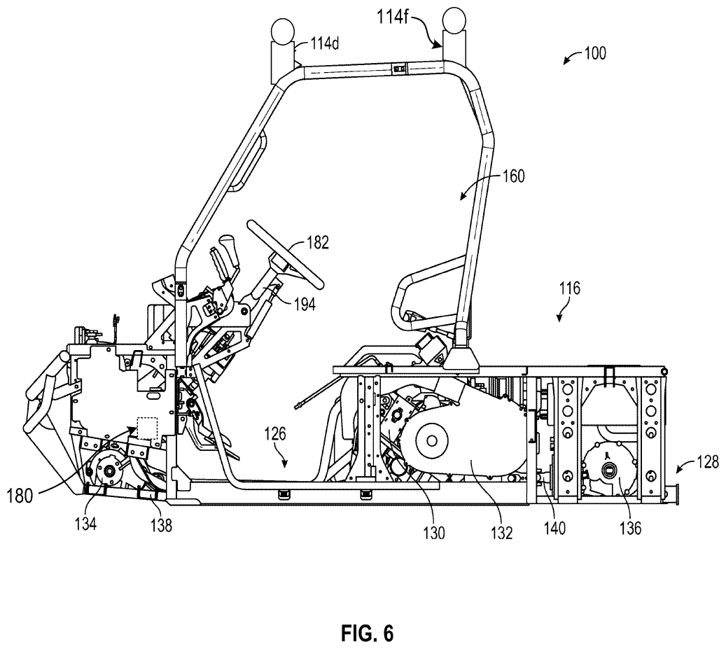

As described herein, one or more of ground engaging members 102 are operatively coupled to a power plants 130 (FIG. 6) to power the movement of vehicle 100. Example power plants include internal combustion engines and electric motors with associated batteries or other electric power sources.

Referring to FIG. 1, a first set of wheels, one on each side of vehicle 100, generally correspond to a front axle 108. A second set of wheels, one on each side of vehicle 100, generally correspond to a rear axle 110. Although each of front axle 108 and rear axle 110 are shown having a single ground engaging members 102 on each side, multiple ground engaging members 102 may be included on each side of the respective front axle 108 and rear axle 110.

As configured in FIG. 1, vehicle 100 is a four-wheel, two-axle vehicle. In other examples, one or more modular subsections (not pictured) may be added to vehicle 100 to transform vehicle 100 into a three-axle vehicle, a four-axle vehicle, and so on.

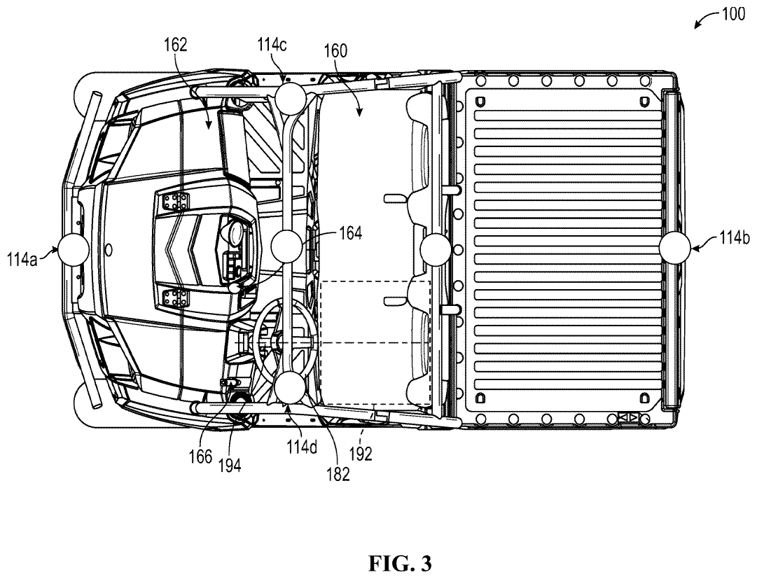

Vehicle 100 includes an operator area 160 generally supported by operator area 126 of frame 116 and enclosed by a roll over protection system 117 (hereinafter, ROPS 117). Operator area 160 includes seating 161 for one or more passengers. A vehicle operator position 192 on seating 161 is represented in FIG. 3. Operator area 160 further includes a plurality of operator controls 180 by which an operator may provide input into the control of vehicle 100. Controls 180 include a steering wheel 182 coupled to a steering column 194 which is operable coupled via linkage or optional electronic power steering system 180 to one or more ground engaging members 102. Rotation of steering wheel 182 by the operator changes an orientation of one or more of ground engaging members 102, such as the wheels associated with front axle 108, to steer vehicle 100. A steering column 194 is connected to steering wheel 182 (FIGS. 3 and 6). In some examples, rotation of steering wheel 182 changes an orientation of the wheels of front axle 108 and rear axle 110 to provide four-wheel steering. Controls 180 also include a first foot pedal actuatable by the vehicle operator to control the acceleration and speed of vehicle 100 through the control of power plant 130 and a second foot pedal actuatable by the operator to decelerate vehicle 100 through a braking system.

Controls 180 may also include gear shift input control 164, which is operatively coupled to the shiftable transmission of transmission 132 (FIG. 6) to communicate whether the shiftable transmission is in a low forward gear, a high forward gear, a reverse gear, neutral, and, if included, a park position. Although gear shift input control 164 is shown as a lever, other types of inputs may be used. Gear shift input control 164 is positioned on a right-hand side of steering column 194.

Controls 180 may also include a parking brake input control 166. Parking brake input control 166 is operatively coupled to a parking brake of vehicle 100. In one embodiment, the parking brake is positioned on one of drive line 138 and drive line 140. In one embodiment, a master cylinder that is operatively coupled to parking brake input control 166 is positioned underneath a dashboard body member 161. Although, parking brake input control 166 is shown as a lever, other types of inputs may be used. Parking brake input control 166 is positioned on a left-hand side of steering column 194.

Vehicle 100 also includes one or more cameras positioned on any suitable portion of vehicle 100 as illustrated by front camera 114a, rear camera 114b, left camera 114c, right camera 114d, center front camera 114e, and center rear camera 114f (collectively, cameras 114). Although described herein as including visible light cameras, in other examples, cameras 114 may include, but are not limited to, infrared cameras, light detection and ranging (LiDAR) devices, radar devices, ultrasonic devices, global positioning system (GPS) devices, magnetometer devices, and radio devices. For example, cameras 114 may each include an ultra-wideband (UWB) radio, such that the position of second UWB radio device may be determined. As another example, cameras 114 may include one or more infrared and/or visible light cameras, such that computer vision techniques may be used to perform object recognition to identify one or more objects, such as portions of vehicle 100, objects in an environment around vehicle 100, or a heat signature of an object near vehicle 100.

In some examples, cameras 114, or devices operatively coupled to cameras 114, may be configured to learn and/or recognized selected objects using computer vision and/or machine learning techniques (e.g., to identify an object and/or to classify an identified object), such that the object may be tracked, followed, avoided, and/or used for other processing according to aspects described herein.

In some examples, a distance to and/or direction of travel of an object may be determined in relation to vehicle 100, for example, based on the size and location of a group of one or more pixels associated with the object in image data that is obtained from cameras 114. Additionally, or alternatively, a size, shape, and/or position of an object may be determined based on a predetermined size and/or shape of the object and a predetermined position of the camera relative to the object, even when the object is at least partially obscured from the light of sight of the camera. For example, a wheel 104 may be at least partially obscured by the line of sight of camera 114e by body panels of vehicle 100, however, image data from camera 114e and a known position of camera 114e relative to wheel 104 may be used to determine a position of a wheel 104 in relation to an environment around vehicle 100. In this way, cameras 114 may be configured to generate a virtual projection of an object even when the object is not in a direct line of sight of cameras 114.

When cameras 114 includes multiple cameras, object detection, depth/distance detection, and/or location detection may be improved using image data that is obtained from different perspectives. For example, a set of anchor points may be identified for the perspective of each respective camera, which may be used to generate a two-dimensional (2D) or three-dimensional (3D) representation of an object and/or at least a part of the environment around vehicle 100. It will be appreciated that any of a variety of additional or alternative techniques may be used in other examples, including, but not limited to, photogrammetry and simultaneous localization and mapping (SLAM).

In some instances, cameras 114 may include an emitter and a detector. For example, a first camera of cameras 114 may be an infrared light source, while a second camera of cameras 114 may be an infrared detector, such as a camera capable of detecting infrared light. Accordingly, a target object having a higher degree of infrared reflectivity relative to a surrounding environment or having a specific pattern may be detected by cameras 114, thereby enabling vehicle 100 to detect objects. For example, the target object may be attached to an operator or to another vehicle. As another example, the target object may be part of or otherwise integrated into a clothing garment, such as a vest. The target object may have one or more known dimensions, such that a distance between vehicle 100 and the target object may be determined based on the size of the object as captured by cameras 114, while the bearing may be determined based on the displacement of the object as compared to a center position of cameras 114. As another example, the bearing may be determined using a plurality of cameras, such that a displacement of the object may be determined for each camera and processed accordingly to generate a bearing of the target in relation to vehicle 100.

While a plurality of cameras 114a through 114f are illustrated, it will be appreciated that any number of sensors may be used. For example, vehicle 100 may include only a single camera 114e mounted at a front center portion of ROPS 117. Further, each of cameras 114 need not be the same type of device. For example, a visible light camera may be used in combination with a GPS device to provide higher resolution positioning than may be obtained with either sensor type individually. It will also be appreciated that cameras 114 may be positioned at any of a variety of other locations on vehicle 100 and need not be limited to positions depicted.

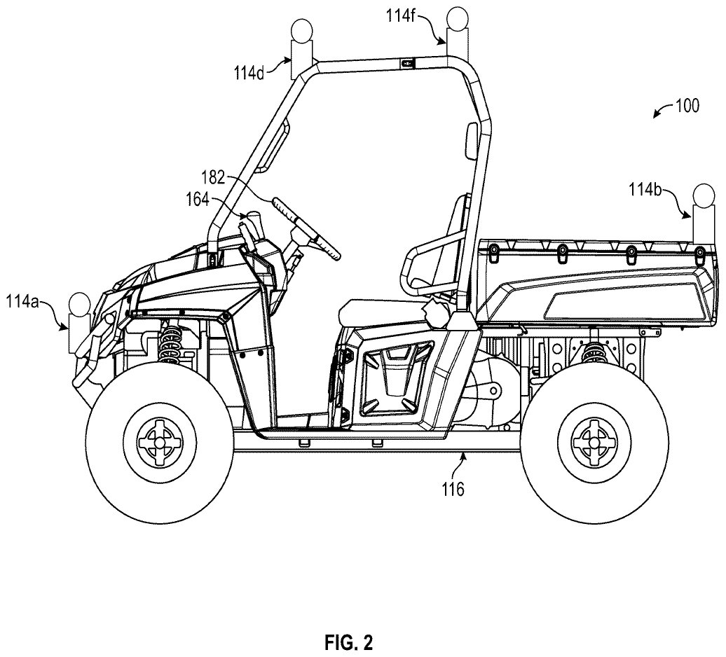

As illustrated in FIG. 2, cameras 114 may be positioned on a roof of vehicle 100 or a top portion of a roll cage 117. In some examples, cameras 114 may be placed at a front portion of the vehicle to detect objects forward of vehicle 100. Additionally, or alternatively, cameras 114 may also be placed at a rear of vehicle 100 to detect objects rearward of vehicle 100. Front and rear positioned cameras 114 may also be positioned and configured to detect objects on the left or right sides of vehicle 100, in addition to detecting forward- and rearward-located objects. In some examples, one or more cameras 114 may be located on one or more sides of vehicle 100, in addition to front-and rear-positioned sensors. Cameras 114 may be connected to a variety of components of vehicle 100, including frame 116, body panels, and so on.

Accordingly, and as explained further below, cameras 114 may be used to provide object-detection and object-avoidance. For instance, cameras 114 may be used to identify and/or track an object. Data output from cameras 114 may be processed to identify objects and/or distinguish between a human operator, a target object, a vehicle, and/or extraneous objects such as grass, trees, or fencing, among other examples.

Referring to FIG. 6, a power plant 130, illustratively an internal combustion engine, is supported by frame 116. Other examples of power plant 130 may include, but are not limited to, a multifuel engine capable of utilizing various fuels, such as that described in U.S. Pat. No. 7,431,024, entitled “Method and Operation of an Engine,” the entire disclosure of which is incorporated by reference herein. In one embodiment, power plant 130 is a hybrid electric engine, such as the hybrid engine described in U.S. Pat. No. 10,744,868, entitled “Hybrid Utility Vehicle,” the entire disclosure of which is expressly incorporated by reference herein. In one embodiment, power plant 130 is an electric motor, such as the electric motor described in U.S. patent application Ser. No. 17/702,050, entitled “Electric Recreational Vehicle,” the entire disclosure of which is incorporated by reference herein.

Power plant 130 is coupled to a front differential 134 and a rear differential 136 through a transmission 132 and respective drive line 138 and drive line 140. Drive line 138 and drive line 140, like other drive lines mentioned herein, may include multiple components and are not limited to straight shafts. For example, front differential 134 may include two output shafts (not pictured), each coupling a respective ground engaging members 102 of front axle 108 to front differential 134. In a similar fashion, rear differential 136 includes two output shafts, each coupling a respective ground engaging members 102 of rear axle 110 to rear differential 136.

In one embodiment, transmission 132 may include a shiftable transmission and a continuously variable transmission (“CVT”). The CVT is coupled to power plant 130 and the shiftable transmission. The shiftable transmission is coupled to drive line 138, which is coupled to front differential 134 and to drive line 140 which is coupled to rear differential 136. In one embodiment, the shiftable transmission is shiftable between a high gear for normal forward driving, a low gear for towing, and a reverse gear for driving in reverse. In one embodiment, the shiftable transmission further includes a park setting, which locks the output drive of the shiftable transmission from rotating. In other examples, one or more axles (e.g., axle 108 or 110) may be non-powered axles.

Various configurations of front differential 134 and rear differential 136 are contemplated. Regarding front differential 134, in one embodiment front differential 134 has a first configuration wherein power is provided to both of the ground engaging members 102 of front axle 108 and a second configuration wherein power is provided to one of ground engaging members 102 of front axle 108.

Regarding rear differential 136, in one embodiment rear differential 136 is a locked differential wherein power is provided to both of the ground engaging members 102 of rear axle 110 through the output shafts. When rear differential 136 is in a locked configuration power is provided to both wheels of rear axle 110. When rear differential 136 is in an unlocked configuration, power is provided to one of the wheels of rear axle 110.

Additional discussion of an embodiment of a wheeled vehicle 100 and related aspects are disclosed in U.S. Pat. No. 7,950,486, entitled “Vehicle,” the entire disclosure of which is expressly incorporated by reference herein in its entirety. Embodiments of vehicle 100 that include snowmobiles are described in U.S. Pat. No. 8,590,654, entitled “Snowmobile,” in U.S. Pat. No. 8,733,773, entitled “Snowmobile Having Improved Clearance for Deep Snow,” in U.S. Patent Pub. No. 2014/0332293A1, entitled “Snowmobile,” and in U.S. Pat. No. 11,110,994, issued Sep. 7, 2021 and entitled “Snowmobile,” all of which are incorporated herein by reference in their entireties.

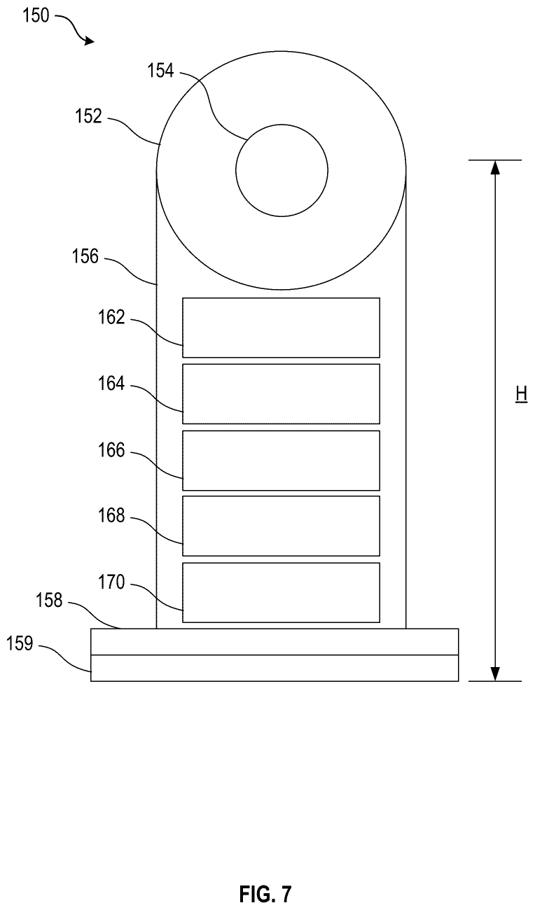

FIG. 7 is a conceptual diagram illustrating an example camera 150 of a recreational vehicle vision system that is mountable to a roll-over protection system ROPS) of a recreational vehicle (e.g., ROPS 117 of vehicle 100). Camera 150 may be the same as or substantially similar to cameras 114 described above in reference to FIGS. 1-6, except for the differences described herein. Camera 150 is self-contained and, optionally, includes a toolless coupling configured to removable fix camera 150 to a select portion of a vehicle (e.g., ROPS 117, frame 116, or body panels of vehicle 100).

Camera 150 includes a camera head 152 that is coupled to a body 156 and houses a sensor device 154 (hereinafter, device 154). Camera head 152, device 154, or both may be moveably coupled to body 156 such that camera head 152, device 154, or both may rotate, tilt, or both relative to body 156. In this way, a field of view of device 154 may be controlled relative to a fixed position of body 156.

Camera head 152 may include a protective covering, at least a portion of which is transparent to device 154 (e.g., transparent to visible light, infrared light, radio waves, or other selected bands of radiation). Device 154 may include a visible camera or other suitable device such as infrared cameras, LiDAR devices, radar devices, ultrasonic devices, GPS devices, magnetometer devices, accelerometers, gyroscopes, inertial devices, and radio devices, as described above. In some examples, device 154 may include any suitable field of view, such as at least a 135-degree field of view, at least a 180-degree field of view, a 360-degree field, or any suitable field of view therebetween.

Body 156 is configured to extend camera head 152 a height H above the portion of vehicle 100 to which body 156 is attached. The height H, e.g., height of body 156, may include any suitable distance. In some examples, the height H may be within a range from about 10 centimeters (cm) to about 100 cm, such as within a range from about 15 cm to about 50 cm. The height H may be determined based on a field of view of device 154 relative to one or more portions of vehicle 100. For example, height H may be selected such as at least a portion of ground engaging members 102 are in a line of sight of device 156.

Body 156 may house one or more components of camera 150. The components of camera 150 may include, but are not limited to, one or more electric motors or actuators 162 (hereinafter, motors 162), processing circuitry 164, memory 166, communication circuitry 168, and a power source 170.

Motors 162 are configured to move at least one of camera head 152 and device 154 relative to body 156. The motion of camera head 152 and/or device 154 is configured to change the field of view of device 154. In some examples, upon installation of camera 150 to a portion of vehicle 100, motors 162 may be configured to align the field of view of device 154 to a predetermined field of view. For example, camera 150 may include a predetermined field of view based, at least in part, on select portions of the vehicle 100 within the field of view. Upon installation of camera 150 on vehicle 100, motors 162 may rotate or tile at least one of camera head 152 and device 154 to align a detected field of view with the predetermined field of view.

Processing circuitry 164 may include one or more microprocessors, microcomputers, microcontrollers, application specific integrated circuity (ASIC), or similar device, and may be configured to process signals or data, including executable computer readable instructions, such as computer programs, code, or the like, stored in memory 166. Processing circuitry 164 is configured to receive from device 154 image data indicative of an environment around vehicle 100. The environment around vehicle 100 may be within the field of view of device 154. Processing circuitry 164 can optionally process the image data to enable camera to transmit the image data. For example, processing circuitry 164 may process the image data and send the image data to either memory 166 or communications circuitry 168.

Memory 166 is configured to store various types of vehicle data and executable computer-program instructions. Memory 166 includes computer-readable media in the form of volatile and/or nonvolatile memory and may be removable and/or non-removable. For example, memory 166 may include random access memory (RAM), read only memory (ROM), electronically erasable programmable read only memory (EE-PROM), flash memory, optical or magnetic storage devices, and/or other medium that can be used to store information and can be accessed by electronic devices.

Communications circuitry 168 is operatively coupled to processing circuitry 164 and configured to communicate with one or more devices remote from camera 150 by transmitting and/or receiving data. For example, communications circuitry 168 may transmit and/or receive radio signals on a radio network such as a cellular radio network. Examples of communications circuitry 168 include a network interface card (e.g. such as an Ethernet card), an optical transceiver, a radio frequency transceiver, or any other type of device sending and/or receiving information. Other examples of communications circuitry 168 may include Bluetooth®, cellular (e.g., 3G, 4G, or 5G), LPWAN, and Wi-Fi® radios. As another example, communications circuitry 168 may communicate with devices by transmitting and/or receiving data via wired communication. In this way, camera 150, by processing circuitry 164 via communications circuitry 168, may be configured to transmit data to and/or receive data from a remote device such as remote computing devices or controllers of vehicle 100.

Power source 170 is operatively coupled to one or more of device 154, motors 162, processing circuitry 164, memory 166, and communications circuitry 168 to provide electrical power to these components. In some examples, power source 170 includes a battery, such as one or more of a primary battery, a rechargeable battery, a lithium-ion battery, an alkaline battery, or the like.

By housing the components of camera 150, body 156 enables camera 150 to be installed on various portions of vehicle 100 and removable from vehicle 100. In some examples, attachment to a portion of vehicle 100 may be facilitated by a removable coupling 158 fixed to body 156 that engages with a base unit 159.

Base unit 159 may be configured to be fixed to a portion of vehicle 100. For example, base unit 159 may include a polymeric plate having an adhesive backing on a first surface, the adhesive backing configured to adhere base 160 to a portion of the vehicle 100. Additionally, or alternatively, base unit 159 may include a magnet configured to magnetically couple base unit 159 to a ferrometal surface of a portion of vehicle 100. In other examples, base unit 159 may be configured to receive or otherwise define a quick release coupling for interfacing with a portion of vehicle 100, such as the quick release couplings described one or more of U.S. patent application Ser. No. 17/985,977, entitled “Article Mounting System for A Vehicle,” and International Patent Application No. WO2024006447, entitled “Cargo Area for a Utility Vehicle,” the entirety of each of which is incorporated by reference herein.

A second surface of base unit 159, opposing the first surface, may include or otherwise define a first portion of removable coupling 158. Body 156 may include or otherwise define a second portion of removable coupling 158. The first portion of removable coupling 158 may removably engage the second portion of removable coupling 158. For example, the first and second portions of removable coupling 158 may define a quick release coupling as described above, a twist lock coupling, a threaded coupling, a plunger coupling, a cam lock coupling, or the like.

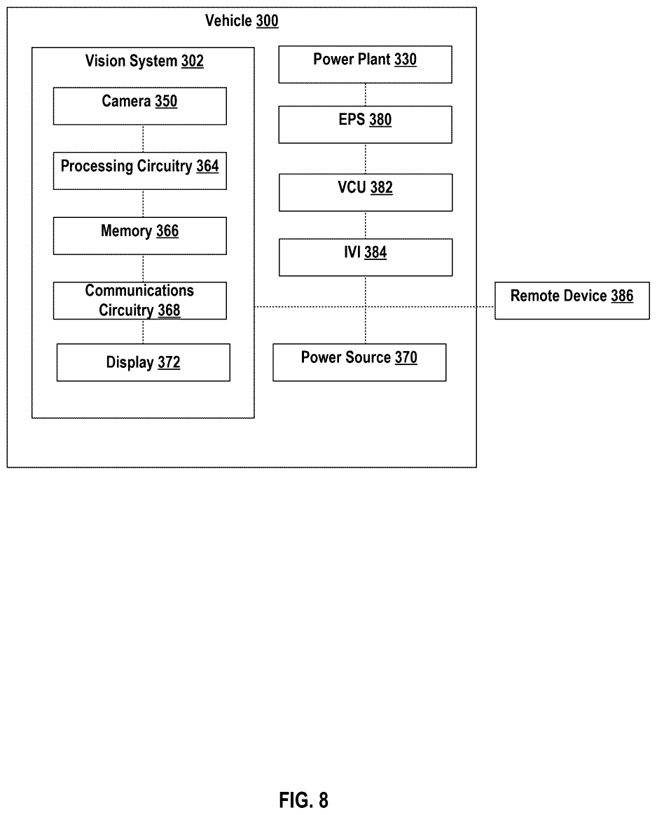

FIG. 8 is a conceptual diagram illustrating an example recreational vehicle vision system 302 (hereinafter, vision system 302) of a recreational vehicle 300 (hereinafter, vehicle 300). Vision system 302 is configured to enable an operator of vehicle 300 to visualize objects, including portions of vehicle 300, that are obscured from the view of at least one of a camera 350 of the vision system 302 or an operator of vehicle 300. In this way, vision system 302 is configured to facilitate complex maneuvers of vehicle 300 such as during trailer loading and unloading procedures or when navigating constrained segments of trails when vehicle 300 may contact objects on the trail such as trees, rocks, barriers, or the like.

Vehicle 300 may be the same as or substantially similar to vehicle 100 described above in reference to FIGS. 1-6, except for the differences describe herein. For example, vehicle 300 includes a power plant 330, an electronic power steering system 380 (hereinafter, EPS 380), a vehicle control unit 382 (hereinafter, VCU 382), an in-vehicle infotainment system 384 (hereinafter, IVI 384), and a power source 370. Power plant 330 and EPS 380 may be the same or substantially similar to power plant 130 and EPS 180, respectively, as described above in reference to FIGS. 1-6. Power source 370 may be the same as or substantially similar to power source 170 described above in reference to FIG. 7. VCU 384 includes devices and systems configured to control one or more operations of vehicle 300, such as braking, acceleration/deceleration, steering, suspension, powertrain, electrical, and so on. In some examples, VCU 384 may include, control, or otherwise communicate with one or more of an engine control unit (ECU) of power plant 330, EPS 380, IVI 384, and vision system 302.

Vision system 302 includes camera 350, processing circuitry 364, memory 366, communications circuitry 368, and a display 372. Each of camera 350, processing circuitry 364, memory 366, and communications circuitry 368 may be the same as or substantially similar to camera 150, processing circuitry 164, memory 166, and communications circuitry 168, respectively, as described above in reference to FIG. 7, except for the differences described herein. For example, processing circuitry 364, memory 366, and communications circuitry 368 may co-located at camera 350 or may include separate or otherwise dispersed components relative to processing circuitry 164, memory 166, and communications circuitry 168, respectively.

Vision system 302 also includes a display 372. Display 372 may include any suitable human machine interface having one or more interfaces configured to output information, such as visual information, to an operator and, optionally, receive input from the operator. Display 372 may include display screen, a touch screen, a heads-up display, a voice-recognition system, buttons, switches, and so on. In some examples, display 372 may define at least a portion of an IVI 384 or otherwise may be fully or partially integrated into vehicle 100. In other examples, display 372 may define a portion of a remote device 386, such as a display or a smart phone or tablet.

IVI 384 may be substantially similar to or otherwise define display 372. For example, IVI 384 may include any suitable human machine interface having one or more interfaces configured to output information, such as visual information, to an operator and, optionally, receive input from the operator.

During operation of vehicle 300 with vision system 302, processing circuitry 364 is configured receive image data from camera 350. The image data is indicative of an environment around vehicle 300. In some examples, the image data may include objects including, but not limited to, trailers, transport vehicles, ramps, trees, rocks, barriers, or the like. Additionally, the image data may include at least a portion of vehicle 300. For example, when camera 350 is mounted to a center of ROPS of vehicle 300 and forward-facing, at least a portion of the hood and front fenders of vehicle 300 may be within the light of sight of camera 350.

Processing circuitry 364 may be further configured to determine, based on the image data, a position of the object that is obscured from direct view (e.g., line of sight) of at least one of camera 350 and an operator of vehicle 300. For example, the object may be obscured from the direct view of at least one of camera 350 and an operator of vehicle 300 by the portion of the hood and/or front fenders of vehicle 300.

Upon determining that the object is obscured from the direct view of at least one of camera 350 and an operator of vehicle 300, processing circuitry 364 may be configured to generate virtual projection data indicative of the object at the position. For example, when the object includes a portion of vehicle 300, such as a wheel or tire thereon, processing circuitry 364 may determine, based on a predetermined spatial relationship between the portion of the vehicle 300 in the image data and the object, the position of the object in the image data. In this way, processing circuitry 364 may generate a virtual projection of the entirety of one or more wheels and tires of vehicle 300 even though camera 350 may not have direct view of the entire wheels and tires. As another example, when the object includes a fixed object separate from vehicle 300, processing circuitry 364 may determine, based on a last known position of the object from the image data and a known speed and heading of vehicle 300, a position of the object.

After generating the virtual projection data, processing circuitry 364 may transmit display data including at least a portion of the image data and at least a portion of the virtual projection data to display 372. In this way, display 372 is configured to display, based on the display data, at least a portion of the environment around the vehicle and a virtual projection indicative of the object.

Additionally, or alternatively, processing circuitry 364 may transmit, e.g., via communications circuitry 368, the display data to remote device 386. Remote device 386 may include a device having a display, such as a smart phone or tablet. Alternatively, remote device 386 may include a computing device that may further relay the display data to another display device. For example, remote device 386 may include a first remote device, such as a server or cloud computing device, configured to transmit the display data through a mobile application, such as Polaris RIDE COMMAND®, to a second remote device, such as a smart phone, for display.

In some examples, processing circuitry 364 may be configured to receive from a component of vehicle 300, such as EPS 380, VCU 382, or IVI 384, data indicative of a position of the object and update the virtual projection data based on the data indicative of the position of the object. For example, processing circuitry 364 may be configured to receive, from EPS 380, steering angle data that is indicative of a position of wheels or the tires thereon of vehicle 300. Based on the steering angle data, processing circuitry 364 may be configured to update the virtual projection data that is indicative of the position of the wheel or the tires thereon.

In some examples, the components of vision system 302 and, optionally, other components of vehicle 300 may be operatively coupled via a control area network (CAN) bus, as illustrated by dashed lines in FIG. 8. The CAN bus may include any suitable single or dual CAN bus configuration, such as those described in U.S. patent application Ser. No. 18/743,379, entitled “Managing Recreational Vehicles and Accessories,” the entirety of which is incorporated by reference herein.

In some examples, vision system 302 defines a portion of an advanced driver assistance system (ADAS), such as one or more ADAS described in U.S. patent application Ser. No. 18/663,347, entitled “Autonomous and Semi-Autonomous Off-Road Vehicle Control,” the entirety of which is incorporated by reference herein. Consequently, embodiments of the present description provide autonomous or semi-autonomous assistance to operators of vehicle 100 via an ADAS suited for vehicles intended to be operated primarily off the road. For example, vision system 302 may be configured to facilitate loading or unloading from a trailer or transport vehicle.

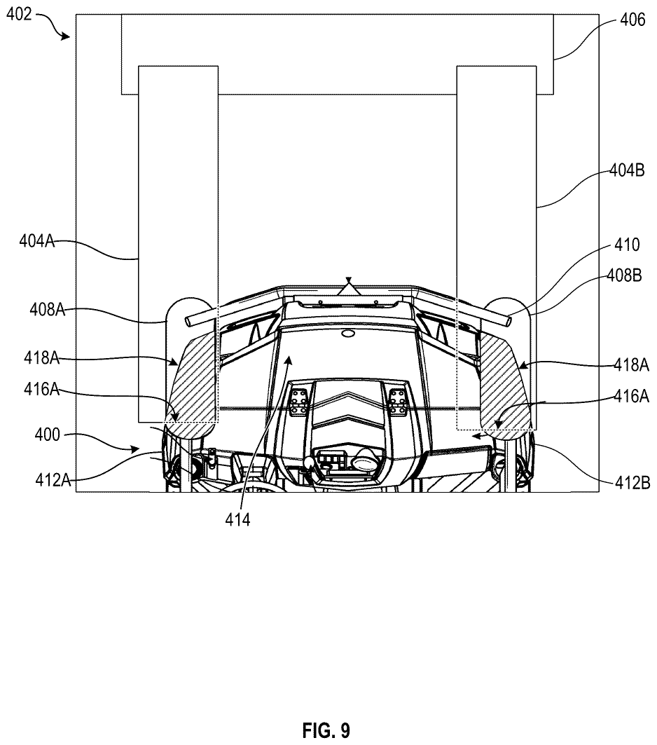

FIG. 9 is a conceptual diagram illustrating and example graphical user interface 402 (hereinafter, GUI 402) illustrating a display generated by the recreational vehicle vision systems described herein. GUI 402 illustrates a representation of vehicle 400 approaching ramps 404A and 404B (collectively, ramps 404) for a loading maneuver onto a transport vehicle 406.

The representation of vehicle 400 is based on image data as described above. For example, a camera (e.g., camera 350) positioned on a front center position of the ROPS of vehicle 400 may capture the image data, which is received by processing circuitry. The representation of vehicle 400 displays a portion of tires 408A and 408B (collectively, tires 408), a front bumper 410, left fender 412A and right fender 412B (collectively, fenders 412), and hood 414. The image data also includes visible portions of ramps 404 and transport vehicle 406.

Processing circuitry of a vision system of vehicle 400 may generate, based on a known position of a camera on vehicle 400 and known relationship of obscured portion of tires 408 to other portions of vehicle 400 (e.g., visible portions of tires 408, front bumper 410, fenders 412, and/or hood 414), a virtual projection 418A of the obscured portion of tire 404A and virtual projection 418B of the obscured portion of tire 408B. In this way, the operator of vehicle 400 may be able to visualize a position of an entirety of tires 404 relative to ramps 404 and/or other objects in the environment around vehicle 400.

When approaching ramps 404, processing circuitry of a vision system may store, via a memory, a size and shape of ramps 404 before ramps 404 are obscured from a direct view of the camera of the vision system. As ramps 404 become obscured from direct view of the camera, the processing circuitry is configured to generate virtual projection 416A of ramp 404A and virtual projection 416B of ramp 404B. In some examples, processing circuitry may perform an adjustment to a size and/or shape of the last known image of ramps to correct for changes from depth perception. Such as correction may be based on a known speed or distance of travel of vehicle 400.

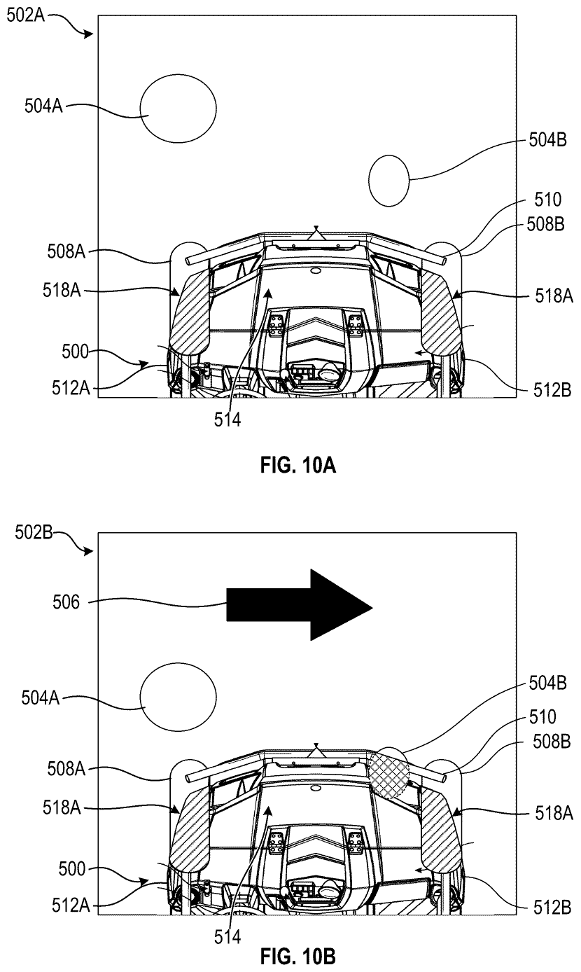

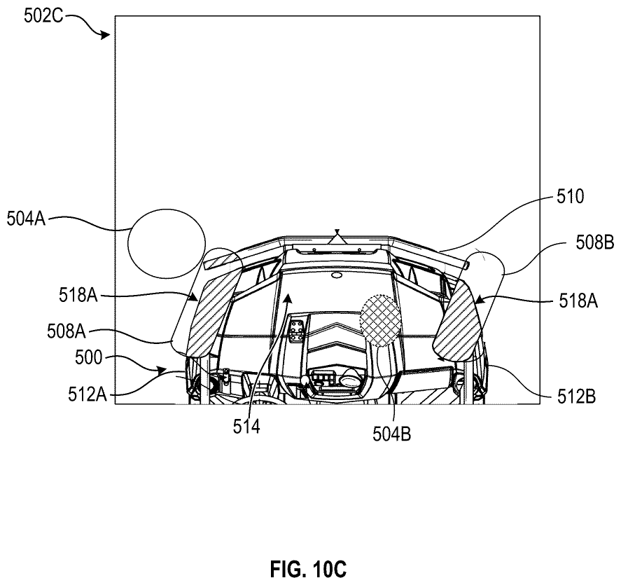

FIGS. 10A through 10C are conceptual diagrams illustrating other example graphical user interfaces 502A and 502B (collectively, GUIs 502) illustrating a display generated by the recreational vehicle vision systems described herein. GUIs 502 illustrate a representation of vehicle 400 approaching a first object 504A that vehicle 500 can traverse and a second object 504B that vehicle 500 cannot traverse.

The representation of vehicle 500 is based on image data as described above. For example, a camera (e.g., camera 350) positioned on a front center position of the ROPS of vehicle 500 may capture the image data, which is received by processing circuitry. The representation of vehicle 500 displays a portion of tires 508A and 508B (collectively, tires 508), a front bumper 510, left fender 512A and right fender 512B (collectively, fenders 512), and hood 514. The image data also includes first object 504A and second object 504B (collectively, objects 504). For example, first object 504A includes a rock having a height less than a known ground clearance of vehicle 500, hence first object 504A may be traversed by vehicle 500. Second object 504B, however, includes a tree, which may not be traversed by vehicle 500.

As vehicle 500 approaches objects 504, as illustrated in FIG. 10B, second object 504A may become obscured by the hood 514 and front bumper 510 of vehicle 500 and a virtual projection of second object is displayed on GUI 502B. Additionally, the vision system may provide to the operator of vehicle 500 an indication that the operator should avoid first object 504A. For example, GUI 502B displays an arrow 506 indicating the direction the driver should steer the vehicle.

As vehicle 500 is steered to avoid first object 504A, GUI 502C may be updated based on steering angle data from an EPS and speed to other positional data associated with vehicle 500 to update the virtual projection of second object 504B and tires 508. Once vehicle 500 has cleared first object 504A, arrow 506 may disappear from GUI 502C. In this way, GUI 502C illustrates tracking of second object 504B and tires 508 as vehicle 500 travels through a turn to avoid first object 504A.

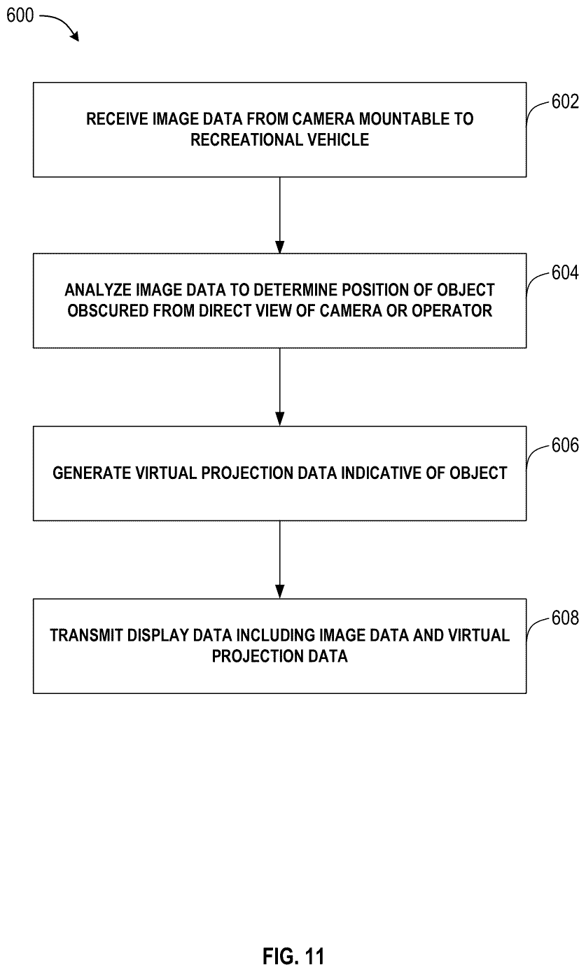

FIG. 11 is a flow diagram illustrating an example technique 600 for generating a virtual projection of an object obscured from a direct line of sight of a camera of a recreational vehicle vision system. Technique 600 is described in reference to vehicle 300 and vision system 302 illustrated in FIG. 8, although the technique may be used with other recreational vehicle vision systems. Additionally, other techniques may be used to provide visual assistance to operators of a recreational vehicle.

The technique illustrated in FIG. 11 includes receiving, by processing circuitry 364, image data from a camera 350 mountable to a portion of a recreational vehicle 300 (602). The image data is indicative of an environment around vehicle 300. In some examples, the technique may include mounting camera 350 to a roll-over protection system (ROPS) of vehicle 300. Additionally, the technique may include controlling camera 350 to provide a 135-degree field of view, which may include adjusting a position of camera 350 or controlling an operation of camera 350. Although described as including a single camera, in some examples, the technique may include using more than one camera, such as two cameras of a stereo vision system.

The technique illustrated in FIG. 11 also includes analyzing, by processing circuitry 364, the image data to determine a position of an object obscured from direct view of at least one of camera 350 and an operator of the recreational vehicle (604).

In some examples, the object includes one or more tires of vehicle 300 and the technique may include receiving, by processing circuitry 364, steering angle data from an EPS 380 of vehicle 300. Also, the technique may further include updating, by processing circuitry 364 based on the steering angle data, the virtual projection data to indicate the position of the one or more tires.

The technique illustrated in FIG. 11 also includes generating, by processing circuitry 364, virtual projection data indicative of the object at the position (606). In some examples, the technique may include updating, by processing circuitry 364, and based on speed or location data from VCU 382 or IVI 384, the position of the object.

In some examples, the technique may include transmitting, by processing circuitry 364 to display 372, display data including at least a portion of the image data and at least a portion of the virtual projection data (608). The technique also may include displaying, by display 372, at least a portion of the environment around the vehicle and a virtual projection indicative of the object. Additionally, or alternatively, the technique may include transmitting, by communication circuitry, at least one of the image data, the virtual projection data, and the display data to a remote device, such as a smart phone, a tablet, server, or cloud computing system.

While the disclosure has been described in connection with what is presently considered to be the most practical and preferred embodiments, it is to be understood that the disclosure is not to be limited to the disclosed embodiments, but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore, it should be understood that while the use of the word preferable, preferably, or preferred in the description above indicates that feature so described may be more desirable, it nonetheless may not be necessary and any embodiment lacking the same may be contemplated as within the scope of the disclosure, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. A recreational vehicle vision system, comprising:
a camera mountable to a portion of a recreational vehicle and configured to generate image data indicative of an environment around the recreational vehicle;
a display device configured to display information to a user; and
processing circuitry communicatively coupled to the camera and the display, wherein the processing circuitry is configured to:
receive image data from the camera,
determine, based on the image data, a position of an object that is obscured from a direct view of at least one of the camera and an operator of the recreational vehicle,
generate virtual projection data indicative of the object at the position, and
transmit display data including at least a portion of the image data and at least a portion of the virtual projection data to the display device.

2. The recreational vehicle vision system of claim 1, wherein the display device displays, based on the display data, at least a portion of the environment around the vehicle and the virtual projection indicative of the object.

3. The recreational vehicle vision system of claim 1, wherein the camera is mounted on a roll-over protection system (ROPS) of the recreational vehicle.

4. The recreational vehicle vision system of claim 1, wherein the camera provides a 135-degree field of view.

5. The recreational vehicle vision system of claim 1, wherein the object comprises one or more tires of the recreational vehicle.

6. The recreational vehicle vision system of claim 5, wherein the processing circuitry is further configured to:
receive steering angle data from an electronic power steering system of the recreational vehicle, and
update, based on the steering angle data, the virtual projection data indicative of the position of the one or more tires.

7. The recreational vehicle vision system of claim 1, further comprising communication circuitry configured to transmit at least one of the image data, the virtual projection data, and the display data to a remote device.

8. A method of enhancing visibility for a recreational vehicle operator, wherein the method comprises:
receiving, by processing circuitry, image data from a camera mountable to a portion of a recreational vehicle, wherein the image data is indicative of an environment around the recreational vehicle;
analyzing, by the processing circuitry, the image data to determine a position of an object obscured from direct view of at least one of the camera and an operator of the recreational vehicle;
generating, by the processing circuitry, virtual projection data indicative of the object at the position; and
transmitting, by the processing circuitry to a display, display data including at least a portion of the image data and at least a portion of the virtual projection data.

9. The method of claim 8, wherein the method further comprises displaying, by the display device, at least a portion of the environment around the vehicle and a virtual projection indicative of the object.

10. The method of claim 8, wherein the camera is mounted on a roll-over protection system (ROPS) of the recreational vehicle.

11. The method of claim 8, wherein the camera provides a 135-degree field of view.

12. The method of claim 8, wherein the object comprises one or more tires of the recreational vehicle.

13. The method of claim 12, wherein the method further comprises:
receiving, by the processing circuitry, steering angle data from an electronic power steering system of the recreational vehicle; and
updating, based on the steering angle data, the virtual projection data to indicate the position of the one or more tires.

14. The method of claim 8, wherein the method further comprises transmitting, by communication circuitry, at least one of the image data, the virtual projection data, and the display data to a remote device.

15. A recreational vehicle, comprising:
a roll-over protection system (ROPS);
a camera mounted to the ROPS;
processing circuitry communicatively coupled to the camera and configured to receive image data therefrom; and
a display device communicatively coupled to the processing circuitry,
wherein the processing circuitry is configured to:
analyze the image data to identify potential obstacles in a path of the recreational vehicle,
generate a graphical overlay indicating the identified potential obstacles, and
cause the display device to present the graphical overlay superimposed on a portion of the image data.

16. The recreational vehicle of claim 15, wherein the camera provides a 135-degree field of view.

17. The recreational vehicle of claim 15, wherein the processing circuitry is further configured to:
detect one or more tires of the recreational vehicle in the image data, and
generate a virtual projection of the one or more tires.

18. The recreational vehicle of claim 17, wherein the processing circuitry is further configured to:
receive steering angle data from an electronic power steering system of the recreational vehicle, and
update the virtual projection of the one or more tires based on the steering angle data.

19. The recreational vehicle of claim 15, further comprising communication circuitry configured to transmit the image data to a remote device.

20. The recreational vehicle of claim 19, wherein the remote device is a mobile phone or tablet configured to display the image data and the graphical overlay.
